(19) United States
(12) Patent Application Publication
(10) Pub. No.: US 2010/0208111 A1
(43) Pub. Date: Aug. 19, 2010

(54) Driving module for imaging apparatus and driving method thereof

(76) Inventor: Chun-Chang Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,348

(22) Filed: Jun. 9, 2009

(30) Foreign Application Priority Data
Feb. 13, 2009 (TW) 98104668

(51) Int. Cl. H04N 5/335

(52) U.S. Cl. 348/294; 348/E05.091

(57) ABSTRACT

A driving method for an imaging apparatus is provided, wherein the driving method is applied to protect an electronic device that includes the imaging apparatus. The method includes the following steps: blanking a vertical pulse signal outputted by a timing generator unit when the electronic device is booting; and then removing the blanking function so that the timing generator unit may output the vertical pulse signal normally to the imaging apparatus when the electronic apparatus has finished booting.

### BACKGROUND OF THE INVENTION

1. Field of the Invention

The present invention relates to a driving module, in particular, to a driving module for an imaging apparatus and a driving method thereof.

2. Description of Related Art

The primary function of an imaging apparatus is to retrieve and then output an incoming image signal. However in order to ensure the normal output function of the imaging apparatus, a normal driving sequence is required. Refer to FIG. 1 which shows a block diagram of a driving module for an imaging apparatus according to the prior art, wherein the initial driving sequence of the image apparatus 90 of the prior art is as follows:

For this particular example, the image apparatus 90 is applied and included within a digital camera (not shown), so that when the digital camera has been turned on and begins booting, the control unit 80 controls the switching unit 84 so as to couple all the transmission routes of the vertical scan lines of the vertical driving unit 86 to a ground reference, and the ground reference may be set by a general purpose input/output (GPIO) provided by the control unit 80.

Next, when the digital camera switches from LiveView to function mode, the control unit 80 controls the switching unit 84 once again, so as to couple all the transmission routes of the vertical scan lines of the vertical driving unit 86 to the vertical pulse signal output terminal of the timing generator unit 82. However because at this time the timing generator unit 82 is already in operation when the digital camera has been turned on and begun booting, which means that the timing generator unit 82 has already generated the vertical pulse signal and the horizontal pulse signal for the vertical driving unit 86 and the horizontal driving unit 88 respectively, so that the output of the image signal did not begin with vertical blanking (v-blanking). Therein, the pulse signals are generated and provided to the driving units because it is required for the scanning of the imaging apparatus 90. The significance here is that the output of the image signal did not begin with vertical blanking (v-blanking), therefore when the transmission routes between the vertical driving unit 86 and the timing generator unit 82 are conduction, the vertical driving unit 86 cannot begin driving the scanning of the imaging apparatus 90 in proper timing control sequence as according to the start of vertical blanking (v-blanking). Further, because image signal did not begin with vertical blanking, the imaging apparatus 90 may directly receive voltage from the vertical pulse signal that is of high voltage level, thereby damaging the imaging apparatus 90.

### SUMMARY OF THE INVENTION

In view of the aforementioned issues, the present invention provides a driving module for an imaging apparatus and a driving method thereof, which, through controlling the point of time when the timing generator unit outputs a synchronous signal, thereby the imaging apparatus may receive the synchronous signal for scanning starting from vertical blanking (V-blanking), and thus overcome the aforementioned issues of the prior art.

To achieve the above-mentioned objectives, the present invention provides a driving method for an imaging apparatus, applied to an electronic device that has the imaging apparatus, the electronic device provides a vertical pulse signal for the imaging apparatus, the driving method includes: when the electronic device is turned on and starts booting, a plurality of vertical scan lines of the imaging apparatus are coupled to a ground reference, so as to halt the receiving of the vertical pulse signal by the imaging apparatus; and then determining and controlling whether or not to resume outputting the vertical pulse signal for the imaging apparatus according to the booting status of the electronic device.

To achieve the above-mentioned objectives, the present invention provides a driving module for an imaging apparatus, applied to an electronic device that has the imaging apparatus, the electronic devices provides a vertical pulse signal for the imaging apparatus, the driving module includes: a timing generator unit, a vertical driving unit, a switching unit, and a control unit. Therein, the timing generator unit includes a register for storing a temporary value, and the temporary value is for controlling and determining whether or not the timing generator unit is to output the vertical pulse signal; the vertical driving unit is for scanning the imaging apparatus according to the vertical pulse signal; the switching unit is for coupling all the transmission routes of the vertical scan lines of the vertical driving unit to a ground reference or to a vertical pulse signal output terminal of the timing generator unit; and the control unit is for setting the temporary value of the register and controlling the switching of the switching unit according to the booting status of the electronic device, so that the timing generator unit only outputs the vertical pulse signal after booting of the electronic device has been completed.

Through the aforementioned technical proposal, the following efficacy is achieved: the timing generator unit only outputs the vertical pulse signal to the imaging apparatus after the booting of the electronic device has been completed, so that the vertical pulse signal required by all the vertical scan lines of the imaging apparatus all begins with vertical blanking (V-blanking), thereby achieves the effect of protecting the imaging apparatus from unintentional high voltage level.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a block diagram of a driving module for an imaging apparatus according to the prior art;

FIG. 2 is a block diagram of a driving module for an imaging apparatus according to an embodiment of the present invention;

FIG. 3 is a flowchart of the driving method for the imaging apparatus according to an embodiment of the present invention; and

FIG. 4 is a timing diagram of the booting execution of the present invention.

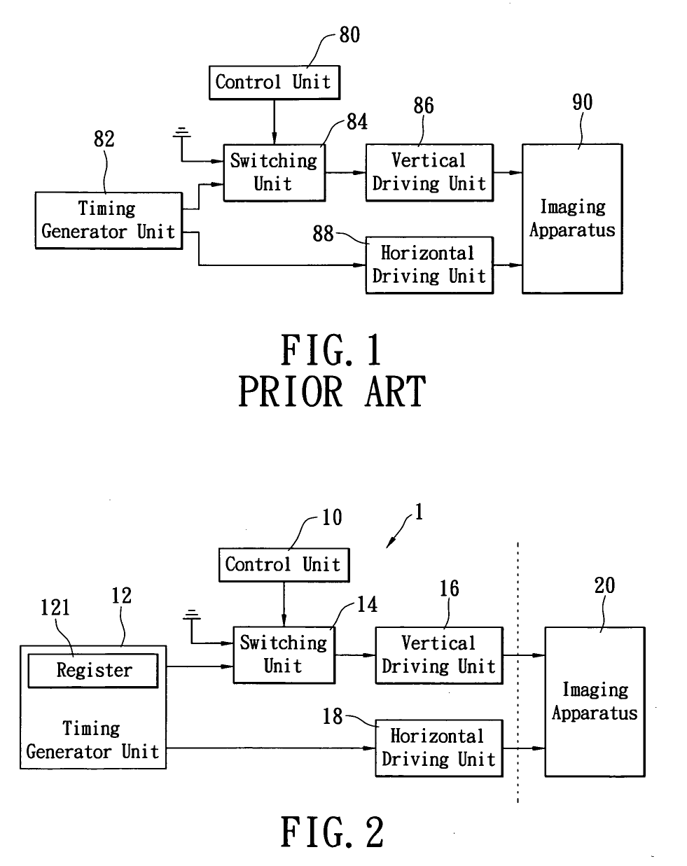

### DETAILED DESCRIPTION OF THE PREFERRED EMBODIMENTS

The present invention provides a driving module for an imaging apparatus and a driving method thereof, which through controlling the point of time when the timing generator unit outputs a synchronous signal, can prevent the imaging apparatus from being damaged due to abnormal booting. Hereafter only the necessary structure and steps are mentioned, however, for those skilled in the art, besides the contents to be described hereafter, there are of course other embodiments, so that therefore the present invention should not be limited to only to the embodiments mentioned hereafter.

Referring now to FIG. 2, wherein the driving module 1 of the FIG. 2 is for providing related working signal (such as a vertical pulse signal V-pulse or a horizontal pulse signal H-pulse) that is required by the imaging apparatus 20 for scanning image signals. Therein, the imaging apparatus 20 is an image sensing device composed of a charge-coupled device (CCD) or a complementary metal-oxide-semiconductor (CMOS), and for the present embodiment the imaging apparatus 20 is combined within an electronic device (not shown) for use, which means that the electronic device is an electronic device with digital photography function.

Referring now to FIG. 2 again, the driving module 1 includes a control unit 10, a timing generator unit 12, a switching unit 14, a vertical driving unit 16, and a horizontal driving unit 18. Therein, the control unit 10 acts as the core control unit for the driving module 1. Therein, the control unit 10 can control and enable the timing generator unit 12 according to the booting status of the electronic device, and furthermore the control unit can control the switching of the switching unit 14, thereby facilitate the activation of the imaging apparatus 20.

The timing generator unit 12 is for providing a synchronous signal, wherein the synchronous signal is required for scanning the imaging apparatus 20. Hereby, the vertical pulse signal and horizontal pulse signal are used as example of the synchronous signal, so as to facilitate explanation. Furthermore, in order to control the point of time when the timing generator unit 12 outputs the synchronous signal, the present embodiment especially installed a register 121 within the timing generator unit 12, so that whether or not the timing generator unit 12 is to output the synchronous signal may be determined according to the temporary value stored within the register 121. Therein, regarding the vertical pulse signal and the horizontal pulse signal, only the vertical pulse signal has the chance of resulting in high voltage (voltage that is over 10 volt), and damaging the imaging apparatus 20, therefore the present invention primarily provides control over the timing generator unit 12 on whether or not to proceed with blanking of the outputted vertical pulse signal.

For example the present embodiment may set the temporary value of the register 121 as a first value (such as a value of 1), wherein the first value indicates the activation of the blanking function, so that the timing generator unit 12 may temporarily halt the output of the vertical pulse signal when the electronic device is booting; on the other hand, the temporary value of the register 121 may be set as a second value (such as a value of 0), wherein the second value indicates the deactivation of the blanking function, so that the timing generator unit 12 may resume the output the vertical pulse signal for the imaging apparatus 20. Therein, the timing generator unit 12 of the electronic device resumes outputting the vertical pulse signal starting from a vertical blanking (V-blanking), which is required for scanning the initial position of the first row pixel of the imaging apparatus.

The aforementioned temporary value of the register 121 is controlled and set by the control unit 10, for example prior to the activation of the timing generator unit 12, the control unit first sets the temporary value of the register 121 as the first value, so that when the timing generator unit 12 has been activated during booting there would be a halt to the output of the vertical pulse signal. Then some time after the electronic device has been turned on, the control unit 10 may determine according to the booting status (such as currently booting or booting complete) so as to set the temporary value of the register 121. Therein when the booting status of the electronic device is such that the booting has been completed, then the control unit 10 set the temporary value of the register 121 to the second value, so that the timing generator unit 12 resumes outputting the vertical pulse signal for the imaging apparatus 20.

The switching unit 14 is coupled between the control unit 10, the timing generator unit 12 and the vertical driving unit 16. The switching unit 14 is primarily for receiving the control of the control unit 10, so as to provide switching for all the transmission routes of the vertical scan lines of the vertical driving unit to a ground reference or to a vertical pulse signal output terminal of the timing generator unit 12, and the ground reference may be set by a general purpose input/output (GPIO) provided by the control unit 10. Additionally, the switching unit 14 may be a multiplexer or a selector, so as to provide switching function for the conduction of the transmission routes to either the ground reference or to the timing generator unit 12.

The vertical driving unit 16 is coupled to the switching unit 14, and the vertical driving unit 16 receives the input of the vertical pulse signal according to the switching of the switching unit 14, so as to drive the scanning of the imaging apparatus 20.

The horizontal driving unit 18 is coupled to the timing generator unit 12, and the horizontal driving unit 18 receives the input of the horizontal pulse signal from the timing generator unit 12, so as to drive the scanning of the imaging apparatus 20.

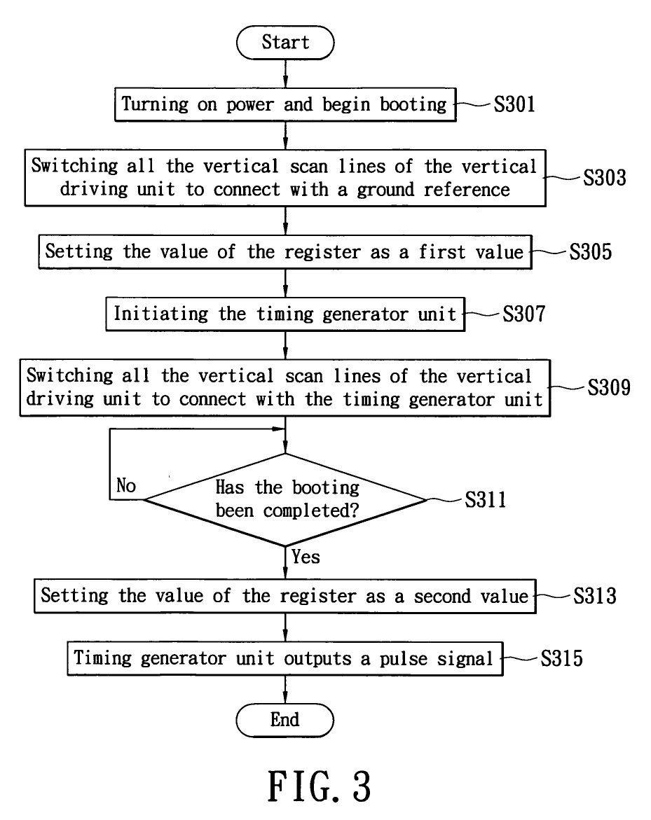

Next please refer to FIG. 3 in conjunction with FIG. 2, wherein FIG. 3 shows a flowchart of the driving method for the imaging apparatus according to an embodiment of the present invention, detailed explanation is as follows:

First turn on the power source of the electronic device so as to begin booting the electronic device (S301), then the control unit 12 controls the switching unit 14 so as to switch all the vertical scan lines of the vertical driving unit 16 to connect with a ground reference (S303); the control unit 10 then set the temporary value of the register 121 of the timing generator unit 12 as a first value (S305), so as to blank the vertical pulse signal outputted by the timing generator unit 12; then the control unit 10 activates the timing generator unit 12 (S307); and the control unit 10 once again control the switching unit 14, this time the control is for the switching unit 14 to switch all the vertical scan lines of the vertical driving unit 16 to connect with the vertical pulse signal output end of the timing generator 12 (S309).

After step S309, continue to determine if the booting status of the electronic device is such that the booting has been completed (S311); if the determination in step S311 is such that the booting has been completed, then the control unit 10 set the temporary value of the register 121 within the timing generator unit 12 as the second value (S313), so that the timing generator unit 12 may resume outputting the vertical pulse signal for the imaging apparatus 20 starting from a vertical blanking (V-blanking), which is required for scanning the initial position of the first row pixel of the imaging apparatus 20; then the timing generator unit 12 may output the vertical pulse signal to the vertical driving unit 16 through the switching unit 14 (S315), so that the imaging apparatus may be activated normally for scanning.

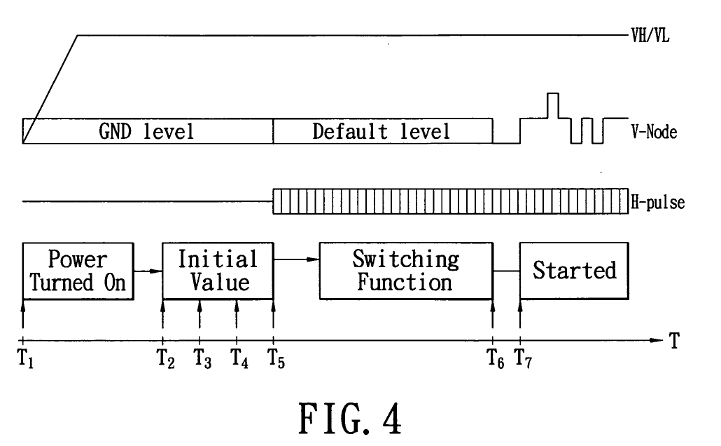

Next an electronic device with digital photography function, such as a digital camera, is used as an example for describing the specific operation process of the present invention. Please refer to FIG. 4, wherein the VH/VL of FIG. 4 represents the voltage used by the imaging apparatus 20 while operating, V-Node represents the vertical pulse signal received by all the vertical scan lines of the imaging apparatus 20, and H-pulse represents the horizontal pulse signal received by the horizontal scan lines of the imaging apparatus 20.

Time T1 of FIG. 4 represents when the power has been turned on for the digital camera and thus indicates the point of time the electronic device starts booting. At this time, the switching unit 14 via switching the transmission routes, couples all the transmission routes of the vertical scan lines of the vertical driving unit 16 to a ground reference. In other words, through the vertical driving unit 16, all the vertical scan lines of the imaging apparatus 20 also display conditions of being connected to the ground reference.

At time T2, the timing generator unit 12 downloads various reference (such a uCode) from the electronic device, which is needed for operation.

At time T3, the control unit 10 sets the temporary value of the register 121 within the timing generator unit 12 as a first value.

At time T4, the control unit 10 activates the timing generator unit 12, however since the temporary value of the register 121 is the first value at this time, so the timing generator unit halts the output of the vertical pulse signal, so that V-Node display a pulse wave level at time T4 that remains the same as in time T1.

At time T5, due to the transmission route switching of the switching unit 14, therefore all the transmission routes of the vertical scan lines of the vertical driving unit 16 is now connected to the vertical pulse signal output terminal of the timing generator unit 12, so that at this time the V-Node display a pulse wave level at a default level corresponding to the vertical pulse signal outputted by the timing generator unit 12. Furthermore, at this time the horizontal driving unit 18 receives the horizontal pulse signal outputted by the timing generator unit 12, so that the horizontal scan lines of the imaging apparatus 20 may begin receiving the driving signal from the horizontal driving unit 18.

At time T6, an input device of the digital camera (such as a function button) may be used for switching function modes for the digital camera, and after the function switching has been completed, the control unit 10 can set the temporary value of the register 121 located within the timing generator unit 12 to a second value, and at this time the booting status for the electronic device can be considered complete (for the present embodiment, how the booting may be completed for the electronic devices may vary according to the type of the electronic devices), so that the timing generator unit 12 can resume outputting the vertical pulse signal, wherein the electronic devise resumes outputting the vertical pulse signal starting from a vertical blanking (V-blanking, which is a signal shown between time T6 and time T7), wherein the vertical blanking is required for scanning the initial position of the first row pixel of the imaging apparatus.

At time T7, the display unit of the digital camera may immediately activate so as to display the input image signal received by the imaging apparatus 20.

Therefore, from the explanation of FIG. 4, it is clear that the technical feature of the present invention is to only allow the timing generator unit 12 to output the vertical pulse signal after the electronic device has completed booting. Thereby ensuring that the timing control sequence of the imaging apparatus 20 begins from vertical blanking (V-blanking), then follow by scanning sequentially, starting from the initial position of the first row pixel of the imaging apparatus 20. Via this way, the present invention ensures of protecting the imaging apparatus 20 from high voltage, which may damage the imaging apparatus 20.

As aforementioned, the present invention installed a register 121 within the timing generator unit 12, and it is through the temporary value of the register 121 that the present invention determines whether or not to activate the function of blanking the vertical pulse signal outputted by the timing generator unit 12. Therefore, the point of time regarding when the timing generator unit 12 output the vertical pulse signal can be effectively controlled to be after the booting of the electronic device has been completed. In other words the initial scanning timing control sequence of the imaging apparatus 20 can be matched with the vertical pulse signal outputted by the timing generator unit 20, so that the vertical pulse signal needed by all the vertical scan lines of the imaging apparatus 20 may begin from a vertical blanking (V-blanking).

Although in the aforementioned embodiment the blanking target from the timing generator unit 12 is the vertical pulse signal, but at the same time it is also possible to apply the same technical feature so as to make the horizontal pulse signal the blanking target.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A driving method for an imaging apparatus, applied to an electronic device that has the imaging apparatus, the electronic device provides a vertical pulse signal for the imaging apparatus, the driving method comprising:
coupling a plurality of vertical scan lines of the imaging apparatus to a ground reference when the electronic device is turned on and starts booting, so as to halt the receiving of the vertical pulse signal; and
determining and controlling whether or not to resume outputting the vertical pulse signal for the imaging apparatus according to the booting status of the electronic device.

2. The driving method for an imaging apparatus according to claim 1, wherein when the booting status of the electronic device is such that the booting has been completed, then resumes outputting the vertical pulse signal to the imaging apparatus.

3. The driving method for an imaging apparatus according to claim 2, wherein the electronic device resumes outputting the vertical pulse signal starting from a vertical blanking (V-blanking), which is required for scanning the initial position of the first row pixel of the imaging apparatus.

4. The driving method for an imaging apparatus according to claim 2, wherein the electronic device comprises a register for storing a temporary value, and the electronic device determines and controls whether or not to output the vertical pulse signal for the imaging apparatus according to the temporary value.

5. The driving method for an imaging apparatus according to claim 4, wherein the register further determines and controls whether or not to output a horizontal pulse signal for the imaging apparatus according to the temporary value.

6. The driving method for an imaging apparatus according to claim 4, wherein while the electronic device is booting, then the temporary value of the register is set as a first value, so as to halt the outputting of the vertical pulse signal for the imaging apparatus; when the booting status of the of the electronic device is such that the booting has been completed, then set the temporary value of the register as a second value, so as to resume outputting the vertical pulse signal to the imaging apparatus.

7. The driving method for an imaging apparatus according to claim 4, wherein the electronic device resumes outputting the vertical pulse signal starting from a vertical blanking (V-blanking), which is required for scanning the initial position of the first row pixel of the imaging apparatus.

8. The driving method for an imaging apparatus according to claim 3, wherein a timing generator unit of the electronic device determines and controls whether or not to output the vertical pulse signal for the imaging apparatus according to the temporary value.

9. The driving method for an imaging apparatus according to claim 1, wherein the electronic device is an electronic device with digital photography function.

10. A driving module for an imaging apparatus, applied to an electronic device that has the imaging apparatus, the electronic device provides a vertical pulse signal for the imaging apparatus, the driving module comprising:
a timing generator unit, the timing generator unit includes a register for storing a temporary value, and the temporary value is for controlling and determining whether or not to output the vertical pulse signal;
a vertical driving unit, for scanning the imaging apparatus according to the vertical pulse signal;
a switching unit, coupled between the timing generator unit and the vertical driving unit, for coupling all the transmission routes of the vertical scan lines of the vertical driving unit to a ground reference or to a vertical pulse signal output terminal of the timing generator unit; and
a control unit, for setting the temporary value of the register and controlling the switching of the switching unit according to the booting status of the electronic device, so that the timing generator unit only outputs the vertical pulse signal after the booting of the electronic device has been completed.

11. The driving module for an imaging apparatus according to claim 10, wherein when the electronic device is turned on and starts booting, the control unit controls the switching unit to couple all the transmission routes of the vertical scan lines of the vertical driving unit to the ground reference, and the control unit sets the temporary value of the register as a first value, so that the timing generator unit halts outputting the vertical pulse signal, then later then control unit controls the switching unit to couple all the transmission routes of the vertical scan lines of the vertical driving unit to the vertical pulse signal output terminal of the timing generator unit.

12. The driving module for an imaging apparatus according to claim 11, wherein when the booting status of the electronic device is such that the booting has been completed, then the control unit sets the temporary value of the register as a second value, so that the timing generator unit resumes outputting the vertical pulse signal.

13. The driving module for an imaging apparatus according to claim 12, wherein the timing generator unit resumes outputting the vertical pulse signal starting from a vertical blanking (V-blanking), which is required for scanning the initial position of the first row pixel of the imaging apparatus.

14. The driving module for an imaging apparatus according to claim 10, wherein the switching unit is a multiplexer or a selector.

15. The driving module for an imaging apparatus according to claim 10, wherein the electronic device is an electronic device with digital photography function.

16. The driving module for an imaging apparatus according to claim 10, further comprising:
a horizontal driving unit, for scanning the imaging apparatus according to a horizontal pulse signal provided by the timing generator unit.
